(19) United States
(12) Patent Application Publication
(10) Pub. No.: US 2019/0373856 A1
(43) Pub. Date: Dec. 12, 2019

(54) Toy Safety

(71) Applicants: Erick Eidus, Kirkland, WA (US); Kandarp Jani, Bellevue, WA (US)

(72) Inventors: Erick Eidus, Kirkland, WA (US); Kandarp Jani, Bellevue, WA (US)

(21) Appl. No.: 16/550,078

(22) Filed: Aug. 23, 2019

Related U.S. Application Data
(63) Continuation of application No. 14/815,897, filed on Jul. 31, 2015.

(51) Int. Cl. A01K 15/02; A01K 29/00

(52) U.S. Cl. CPC A01K 15/021; A01K 15/025; A01K 29/005

(57) ABSTRACT

A toy safety system may allow a toy to safely shut down or dissuade a user from playing with it in the event that the toy is damaged. This may prevent the user from being hurt, as well as protecting other articles. A toy safety system may also include communications hardware, that may allow the toy to communicate with a device to notify a person that the toy is damaged.

### FIELD

This disclosure relates generally to toy safety.

### BACKGROUND

Toys using electronics are very popular. They may be used to entertain a user, for example, a child or pet, for long periods of time, as they vibrate, roll around, make sounds, flash lights, or use other ways to attract and keep attention. Because of a power source, printed circuit boards, electronic components, and often metal parts being integrated, there exists the possibility that damage to a toy may cause damage to other articles, or may harm the user.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, Toy Safety. In one embodiment, it may comprise a toy which may allow a pet to engage in games, exercises, training, and other activities with little to no human oversight. To prevent injuries to the user, damage to other articles, or further damage to the toy itself, the toy may turn off, may send a notification, or may make an audible, visible, tactile, or other indication if it gets compromised. For example, if the toy cracks open, or is damaged in another way, a sensor may detect the damage and activate a notification routine.

The sensor may, for example, detect that a wire grid integrated into an outer cover of the toy has been broken. In another implementation, a fiber optics cable may be used, with the sensor detecting if a light path is interrupted.

Many of the attendant features may be more readily appreciated as they become better understood by reference to the following detailed description considered in connection with the attached drawings.

### BRIEF DESCRIPTION OF THE DRAWINGS

FIG. 1 illustrates a toy with a toy safety system, according to one implementation.

FIG. 2 illustrates a cutaway view of a toy with a toy safety system, according to one implementation.

FIG. 3 is a block diagram illustrating an example of a system capable of supporting toy safety, according to one embodiment.

FIG. 4 is a block diagram illustrating an example of a system capable of supporting toy safety, according to another embodiment.

FIG. 5 is a component diagram of a computing device to which toy safety may be applied according to one embodiment.

Like reference numerals are used to designate like parts in the accompanying drawings.

### DETAILED DESCRIPTION

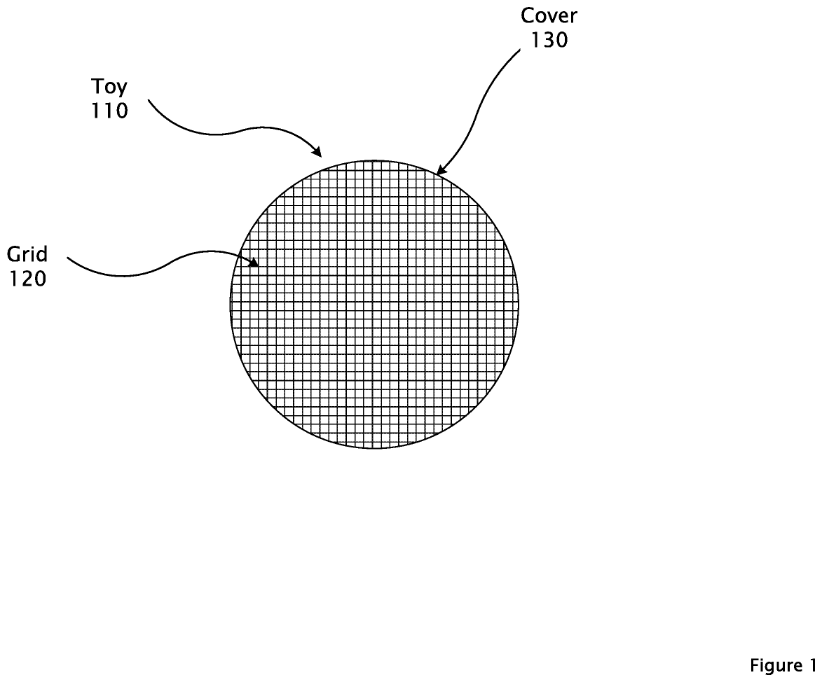

FIG. 1 illustrates Toy 110 with a toy safety system, according to one implementation. Toy 110 may have Cover 130, which may be made of leather, rubber, cloth, or plastic, for example. Grid 120 may be disposed under Cover 130, and may be made of fine wire. In another implementation, Grid 120 may be directly integrated into Cover 130. A current may pass through Grid 120, which may be made to be likely to break or otherwise change if Cover 130 gets damaged. Electronics 210 may include Sensor 220, which may be configured to detect a change in current in Grid 120, and may initiate an action. The current flowing through Grid 120 may be small enough that it will not harm the user of Toy 110.

An action may be designed to notify a person, who may remove or repair Toy 110. Toy 110 may notify a person in various ways. For example, a notification may be a text message, a message via Internet Protocol, for example an IP message via a third-party service such as SNAPCHAT®, FACEBOOK®, TWITTER®, INSTAGRAM®, WHATSAPP®, or a similar service that can send a digital message to a user's device, an email message, a phone call, a video call, a video live-streamed from an IP camera, an audio message played via a smart speaker, for example an AMAZON ECHO® or GOOGLE HOME™, or a BLUETOOTH® speaker, an alert sound played via a smart speaker, a wired speaker, or a BLUETOOTH® speaker, where an alert sound may be a loud or undesirable sound, or a sound played at a specific frequency. An action may also allow the person to send audio to another device. The person may also be able to disable Toy 110 remotely.

An action may also be designed to dissuade a user from continuing to use Toy 110. For example, Toy 110 may flash lights, play a loud sound, play a sound at a specific frequency, which may be ultrasonic, that is undesirable to a user, play a pattern of sounds, vibrate in an undesirable way, deliver an undesirable smell, for example citronella, or may deliver an undesirable taste. One having skill in the art will recognize that other actions may be used to dissuade a user from continuing to use Toy 110.

In another implementation, fiber optics may be used for Grid 120 rather than wire, with Sensor 220 detecting when a light path is interrupted.

In yet another implementation, if Cover 130 is cracked, light sensors disposed within Toy 110 may detect changes in ambient light levels. These light sensors may be distributed throughout the device, or may be in locations in Toy 110 which are most likely to be damaged.

In yet another implementation, readings from light sensors disposed on an outside of Toy 110 may be compared to readings from sensors disposed within Toy 110, to detect a change in the relative light levels. These light sensors may be distributed throughout the device, or may be in locations in Toy 110 which are most likely to be damaged.

In yet another implementation, a microphone and speaker may be used to detect a change in an audio level. The speaker may produce sound within Toy 110, and an audio level may be detected by a microphone. A baseline measurement may be obtained from an undamaged Toy 110, and any change from that baseline may indicate that Cover 130 may be damaged. The sound may or may not be detectable by humans.

In yet another implementation, a strain gauge may be used to detect a change in pressure of the Protective Housing. A level of pressure that deviates from a previously determined baseline may indicate that Toy 110 has been damaged.

One having skill in the art will recognize that many different detection techniques may be used to detect potential safety issues with a toy that has been damaged.

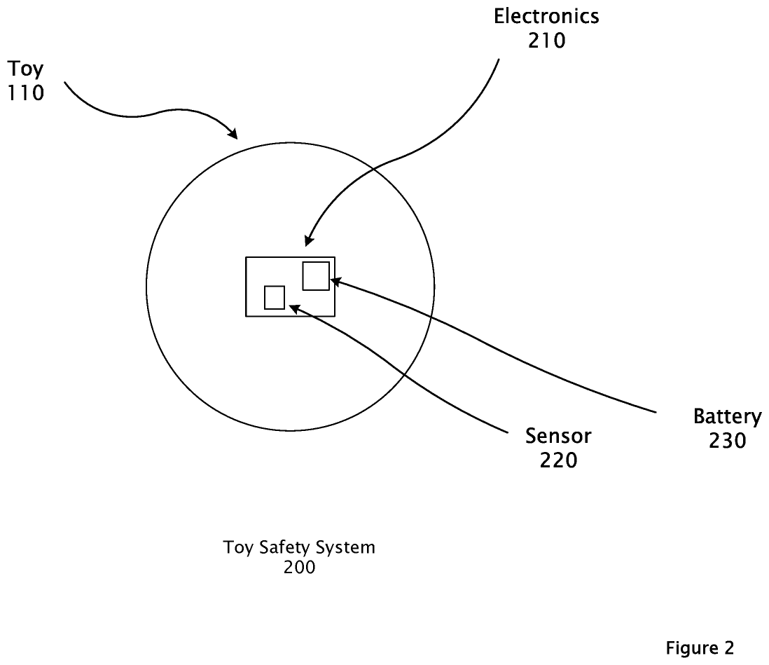

FIG. 2 illustrates a cutaway view of a toy with Toy Safety System 200, according to one implementation. Electronics 210 may be disposed within Toy 110, and may include Sensor 220, which may be configured to detect damage to Toy 110. Electronics 210 may be powered by Battery 230. It may be desirable for Battery 230 to last as long as possible. Sensors within a Smart Pet Toy may be used to determine when and how frequently power should be consumed by Electronics 210.

For example, Toy 110 may only be powered when movement is detected, for example, by an accelerometer. Alternatively, Toy 110 may be powered when a sensor detects that Toy 110 is being manipulated in a way that appears to be different from normal use.

In another implementation, Toy 110 may be powered when a sensor within a Smart Pet Toy detects that Toy 110 is being manipulated in a way that appears to match patterns associated with a Pet trying to damage Cover 130.

Toy 110 may also be powered exclusively only when certain users are interacting with it. Which user is interacting with Toy 110 may be determined in various ways, for example, video recognition, wireless dog tags or collars, RFID, odor, sound, or other technologies.

Toy Safety System 200 may be disabled. Toy Safety System 200 may also be manually activated to check the safety of Cover 130 on demand.

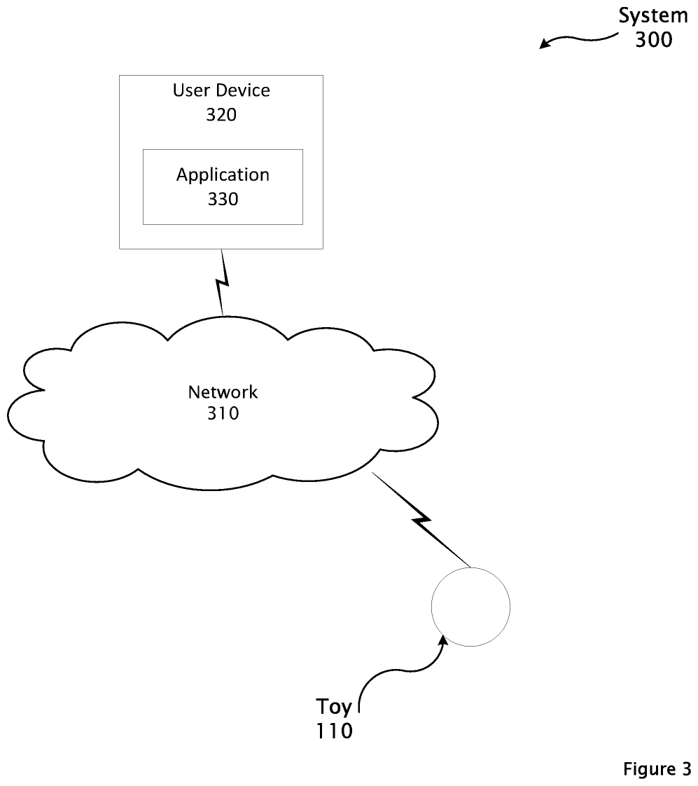

FIG. 3 is a block diagram illustrating an example System 300 capable of supporting toy safety, according to one embodiment. Network 310 may include Wi-Fi, cellular data access methods, such as 3G or 4G LTE, BLUETOOTH®, Near Field Communications (NFC), the internet, local area networks, wide area networks, or any combination of these or other means of providing data transfer capabilities. In one embodiment, Network 310 may comprise Ethernet connectivity. In another embodiment, Network 310 may comprise fiber-optic connections.

User Device 320 may be a smartphone, tablet, desktop computer, laptop computer, smart watch or intelligent eyewear, or other device, and may have network capabilities to communicate with Toy 110.

User Device 320 may have Application 330 running, which may allow receiving notifications from Toy 110, and may allow User Device 320 to control functions on Toy 110. In another implementation, User Device 320 may host a web browser which allows similar interactions with Toy 110. One having skill in the art will recognize that many different approaches to software supporting notifications or control between a user device and a toy are possible.

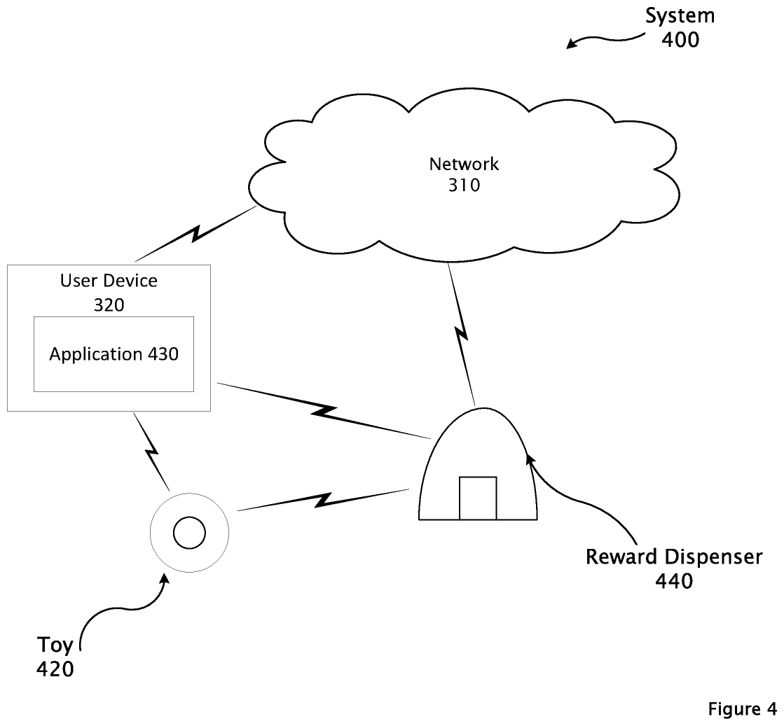

FIG. 4 is a block diagram illustrating an example of System 400 capable of supporting toy safety, according to another embodiment. In this example, Toy 420 may be a dog toy, which may support multiple games or multiple levels or tasks within a game. User Device 320 may access and display mobile applications, such as Application 430, on User Device 320. User Device 320 may access and enable Application 430 through one or more application stores, for example, Google™ Play Store, iTunes®, Apple™ App Store, Blackberry™ AppWorld, Windows Store, or the like. Application 430 may communicate with one or more devices, for example, Reward Dispenser 440 or Pet Toy 420 over Network 310. Application 430 may connect User Device 320 to Toy 420 and provide User Device 320 functionality to communicate notifications or commands between the devices. For example, Application 430 may permit a user to initiate game play, stop game play, and select a level of difficulty on Toy 420 via User Device 320. Initiation of game play may permit the user to select a game played by a pet and communicate settings for the selected game to Toy 420 or other commands to Reward Dispenser 440.

Furthermore, notification as to a pet's progress (i.e., succeeding at a task or struggling at a task) may be communicated to the User Device 320 via Application 430. Upon receipt of a pet's progress, the user may adjust the level of difficulty accordingly. For example, upon notification to a user that a pet is struggling to complete a task at a task level 4, the user may elect to adjust Toy 420 to a lower task level (i.e., easier, less difficult), for example, a task level 2.

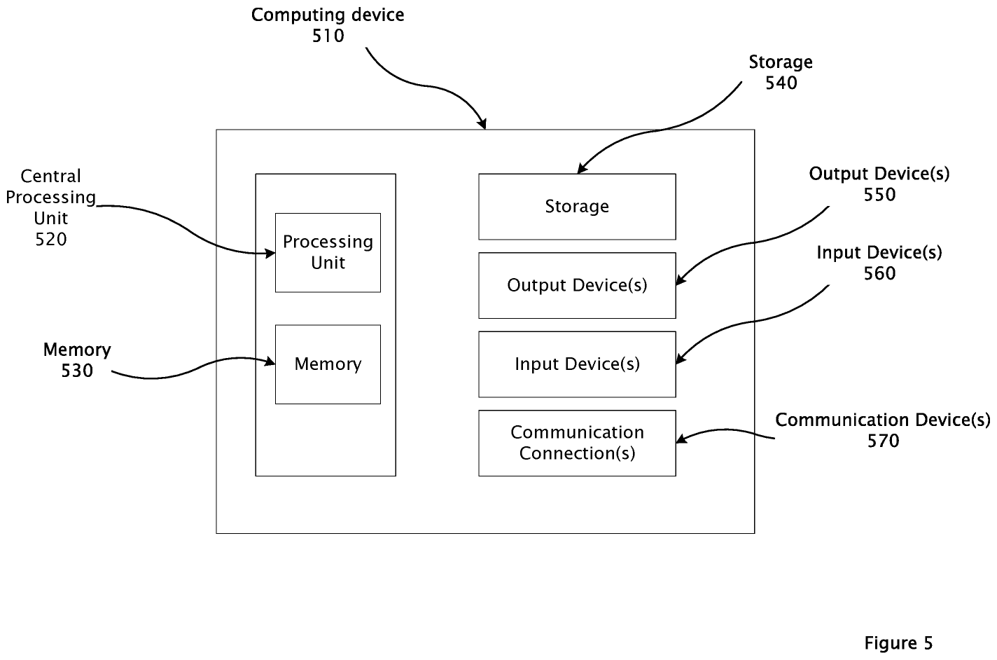

FIG. 5 is a component diagram of a computing device to which a Toy Safety System may be applied according to one embodiment. Computing Device 510 can be utilized to implement one or more computing devices, computer processes, or software modules described herein, including, for example, but not limited to a mobile device. In one example, Computing Device 510 can be used to process calculations, execute instructions, and receive and transmit digital signals. In another example, Computing Device 510 can be utilized to process calculations, execute instructions, receive and transmit digital signals, receive and transmit search queries and hypertext, and compile computer code suitable for a mobile device. Computing Device 510 can be any general or special purpose computer now known or to become known capable of performing the steps or performing the functions described herein, either in software, hardware, firmware, or a combination thereof.

In its most basic configuration, Computing Device 510 typically includes at least one Central Processing Unit (CPU) 520 and Memory 530. Depending on the exact configuration and type of Computing Device 510, Memory 530 may be volatile (such as RAM), non-volatile (such as ROM, flash memory, etc.) or some combination of the two. Additionally, Computing Device 510 may also have additional features/functionality. For example, Computing Device 510 may include multiple CPUs. The described methods may be executed in any manner by any processing unit in Computing Device 510. For example, the described process may be executed by both multiple CPUs in parallel.

Computing Device 510 may also include additional storage (removable or non-removable) including, but not limited to, magnetic or optical disks or tape. Such additional storage is illustrated in FIG. 5 by Storage 540. Computer-readable storage media include volatile and nonvolatile, removable and non-removable media implemented in any method or technology for storage of information such as computer-readable instructions, data structures, program modules, or other data. Memory 530 and Storage 540 are examples of computer-readable storage media. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can access by Computing Device 510. Any such computer-readable storage media may be part of Computing Device 510. But computer-readable storage media do not include transient signals.

Computing Device 510 may also contain Communications Device(s) 570 that allow the device to communicate with other devices. Communications Device(s) 570 is an example of communication media. Communication media typically embody computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared and other wireless media. The term computer-readable media, as used herein, includes both computer-readable storage media and communication media. The described methods may be encoded in any computer-readable media in any form, such as data, computer-executable instructions, and the like.

Computing Device 510 may also have Input Device(s) 560 such as a keyboard, a mouse, a pen, a voice input device, a touch input device, etc. Output Device(s) 550 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions, may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the distant disclosure.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A toy safety system, comprising:
a toy, wherein the toy comprises:
a cover;
a sensor operable to detect when the cover has a damaged section; and
software operable to perform an action when the sensor detects that the cover has a damaged section.

2. The toy safety system of claim 1, wherein the sensor further comprises a sensor that detects if a wire grid integrated into the cover has been broken.

3. The toy safety system of claim 1, wherein the sensor further comprises a sensor that detects if a wire grid disposed under the cover has been broken.

4. The toy safety system of claim 1, wherein the sensor further comprises a light sensor that detects if a fiber optic cable has been broken.

5. The toy safety system of claim 1, wherein the sensor further comprises a plurality of light sensors that detects if the cover has been broken by comparing an ambient light level outside the toy to an ambient light level internal to the toy.

6. The toy safety system of claim 1, wherein the sensor further comprises a plurality of sound sensors that detects if the cover has been broken by comparing an ambient sound level outside the toy to an ambient sound level internal to the toy.

7. The toy safety system of claim 1, wherein when the sensor detects damage, the toy activates a notification routine.

8. The toy safety system of claim 7, wherein notification routine comprises a text message, a notification message, a message via Internet Protocol, an email message, a phone call, a video call, a video live-streamed from an IP camera, an audio message played via a smart speaker, an alert sound played via a smart speaker, an alert sound played via wireless speaker, or an alert sound played via a wired speaker.
